(19) United States
(12) Patent Application Publication
(10) Pub. No.: US 2008/0306690 A1
(43) Pub. Date: Dec. 11, 2008

(54) Wireless network positioning system

(76) Inventor: Chien-Chang Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,432

(22) Filed: Nov. 30, 2007

(30) Foreign Application Priority Data
Jun. 8, 2007 (TW) 96120817

(51) Int. Cl. G01S 5/00; H04Q 7/36

(52) U.S. Cl. 701/300; 455/456.1

(57) ABSTRACT

The present invention discloses a wireless network positioning system to add a function of positioning a mobile communication device to a wireless communication system, wherein a mobile communication device detects intensities of wireless signals from access points and transmits signal intensity data to a LAN server, and an algorithm is used to determine the position of the mobile communication device. Particularly, the present invention utilizes a WLAN architecture to position a mobile communication device in an indoor environment.

### BACKGROUND OF THE INVENTION

1. Field of the Invention

The present invention relates to a positioning system, particularly to a wireless network positioning system.

2. Description of the Related Art

Due to the development of the Internet, information transfer has been accelerated. Recently, mobile communication and WLAN (Wireless Local Area Network) Internet access not only provide mobile information transfer for users but also create new value for users. The competition among various wireless communication technologies will persist and create a heterogeneous multi-access network environment to satisfy diversified requirements of users and meet different application conditions. From its emergence, much attention has been paid on WLAN by consumers, media, manufacturers and governments. The convenience of “wireless” has created an emerging market the traditional wired network cannot achieve.

Nowadays, WLAN has gradually become a standard function of traditional consumer electronics, such as notebook computers and family networks, or emerging products, such as game machines and cameras. With wireless IP (Internet Protocol), VoIP (Voice over IP), or Internet access built in multimedia players, PDA (Personal Digital Assistant) and mobile phones, the standard 802.11 a/b/g for WLAN is expected to penetrate all the territory of consumer electronics.

The wireless communication network based on the Bluetooth or infrared is also very prospering in the field of wireless communication. However, they are hard to incorporate an object-positioning function because of too high a cost and the administration difficulty caused by the intrinsic design thereof. Besides, GPS (Global Positioning System) is only used outdoors and unlikely to perform an indoor positioning task.

### SUMMARY OF THE INVENTION

One objective of the present invention is to provide a wireless network positioning system, which is implemented with the environment of widely established wireless local area networks, wherein a mobile communication device receives several wireless signals of different intensities, and an algorithm is used to compare the intensities with the signal intensities received by neighboring fixed wireless communication modules to calculate the position of the mobile communication device according to the position of the fixed wireless communication modules; then, the positional information is fed back to the mobile communication device.

Another objective of the present invention is to provide a wireless network positioning system, which can apply to a large area or a multi-story building via interconnecting several wireless local area networks with an internet.

Further another objective of the present invention is to provide a method for positioning a mobile communication device with a wireless network, which can work out a physical position of a mobile communication device, whereby complicated calculation is simplified; uncertain factors, such as signal reflection and barrier interference, are reduced, and positioning accuracy is promoted.

To achieve the abovementioned objectives, the present invention proposes a wireless network positioning system, which comprises: at least one local area network server used to administrate a wireless local area network; a plurality of access points located in and linked to the wireless local area network, wherein each access point has a piece of positional data and a footprint, and the footprint overlaps footprints of neighboring access points, and all the footprints jointly form a wireless communication coverage; at least one fixed wireless communication module located at a fixed position of the wireless communication coverage, wherein the fixed position is stored in the local area network server and functions as a fixed reference point; and the fixed wireless communication module receives the wireless signals of the access points inside the wireless communication coverage to acquire several pieces of signal intensity data.

The present invention also proposes a method for positioning a mobile communication device with a wireless network, which comprises: a mobile communication device entering a wireless communication coverage, which is formed of footprints of several access points; the mobile communication device scanning wireless signals and outputting several pieces of signal intensity data of the scanned wireless signals; the mobile communication device transmitting a positional information query and the signal intensity data of the scanned wireless signals to a local area network server; the local area network server comparing the signal intensity data of the scanned wireless signals with several pieces of signal intensity data of several fixed positions to work out a piece of positional information of the mobile communication device; and the local area network transmitting the positional information to the mobile communication device.

### BRIEF DESCRIPTION OF THE DRAWINGS

FIG. 1 is a diagram schematically showing the architecture of a wireless network positioning system according to one embodiment of the present invention;

FIG. 2 is a flowchart of a method for positioning a mobile communication device with a wireless network according to one embodiment of the present invention; and

FIG. 3 is a diagram schematically showing the operation of the wireless network positioning system shown in FIG. 1.

### DETAILED DESCRIPTION OF THE INVENTION

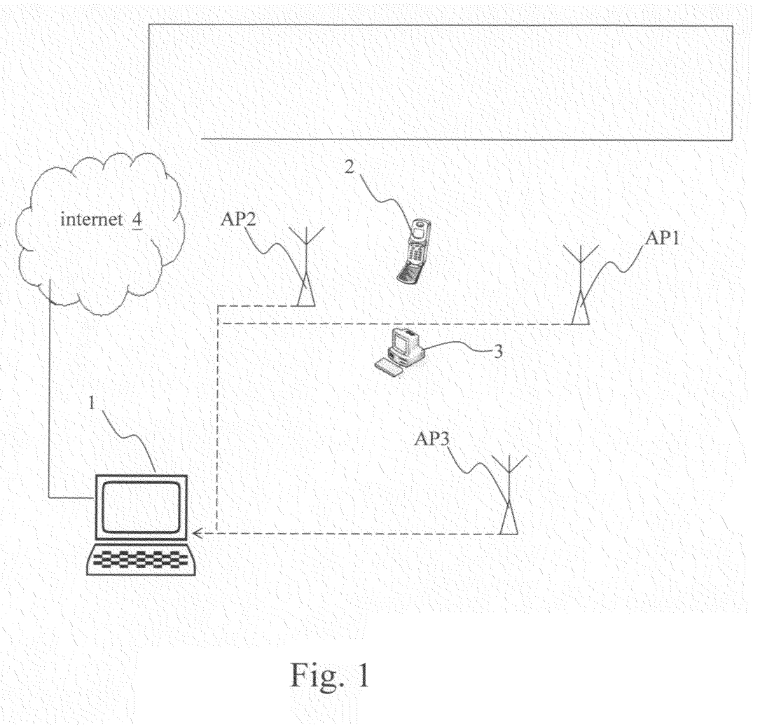

Refer to FIG. 1 a diagram schematically showing the architecture of a wireless network positioning system according to one embodiment of the present invention. In this embodiment, a LAN (Local Area Network) server 1 is linked to an internet 4 and administrates a LAN. Several access points AP1, AP2 and AP3 are arranged in the LAN. The footprint of each access point overlaps the footprints of neighboring access points. The wireless communication coverage of the LAN is formed of the footprints of the access points AP1, AP2 and AP3. The access points AP1, AP2 and AP3 are linked to the LAN server 1 with a wired or wireless method, and the positional information of each access point is stored in the database of the LAN server 1.

A fixed wireless communication module is arranged at a fixed position, such as a computer 3, of the wireless communication coverage. The fixed point functions as a fixed reference point, and the data thereof is stored in the LAN server 1 as a piece of fixed reference point data. The fixed wireless communication module receives wireless signals from the access points AP1, AP2 and AP3 and acquires several pieces of signal intensity data. The several pieces of signal intensity data are respectively transmitted to the access points AP1, AP2 and AP3, which further transmit the signal intensity data to the LAN server 1. The LAN server 1 processes the signal intensity data and fixed reference point data and utilizes an algorithm to work out the position of a mobile communication device 2 inside the wireless communication coverage.

In establishing positional data, the positions of the access points AP1, AP2 and AP3 are static datum points, which provide basal coordinates when the LAN server 1 performs a positioning task. Further, fixed wireless communication modules are arranged in some fixed positions, such as the computer 3. The fixed wireless communication modules are wirelessly linked to the access points AP1, AP2 and AP3 at the fixed positions. The signal intensity information obtained at the computer 3 is stored in the LAN server 1 and functions as a sample. The more the samples, the more accurate the calculated position of the mobile communication device 2.

The abovementioned fixed wireless communication module may also be arranged at a notebook computer or an intelligent household electric appliance, which is wirelessly linked to the internet. In practical applications, the intelligent household electric appliances wirelessly linked to the internet are particularly suitable to function as the fixed wireless communication modules because they are arranged at fixed positions and seldom moved.

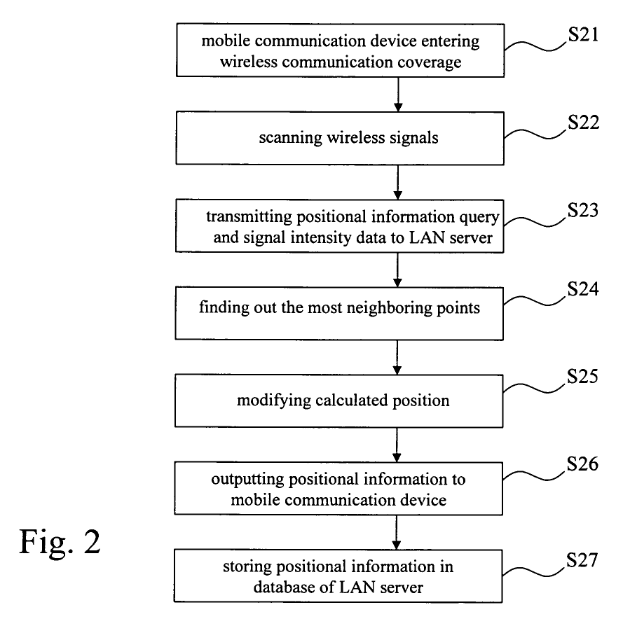

Refer to FIG. 2 a flowchart of a method for positioning a mobile communication device with a wireless network. In Step S21, a mobile communication device enters a wireless communication coverage, which is formed of footprints of several access points. In Step S22, the mobile communication device scans the wireless signals emitted by the access points to acquire several pieces of signal intensity data of the scanned wireless signals. In Step S23, the mobile communication device transmits a positional information query and the signal intensity data of the scanned wireless signals to a LAN server. In Step S24, the LAN server finds out the most neighboring points, wherein an algorithm is used to select the most approximate values from the signal intensity data of several fixed positions and find out the most neighboring points where several most neighboring fixed wireless communication modules are respectively arranged. In Step S25, the calculated position is modified, wherein a multi-point positioning method is used to generate the positional information of the mobile communication device. In Step S26, the positional information is output to the mobile communication device. In Step S27, the positional information of the mobile communication device is stored in the database of the LAN server.

According to one embodiment of the present invention, in Step S24, Euclidean distance is used to work out the most neighboring points from several pieces of signal intensity data of several fixed points according to Equation (1)

$$dist ( a , b ) = \sqrt{{\sum }_{1}^{d} {( {a}_{i} - {b}_{i} )}^{2}} \qquad ( 1 )$$

wherein i=1, 2 . . . d; a=[a1, a2 . . . ad] and b =[b1, b2 . . . bd] are the signal intensities respectively received at Point A and Point B.

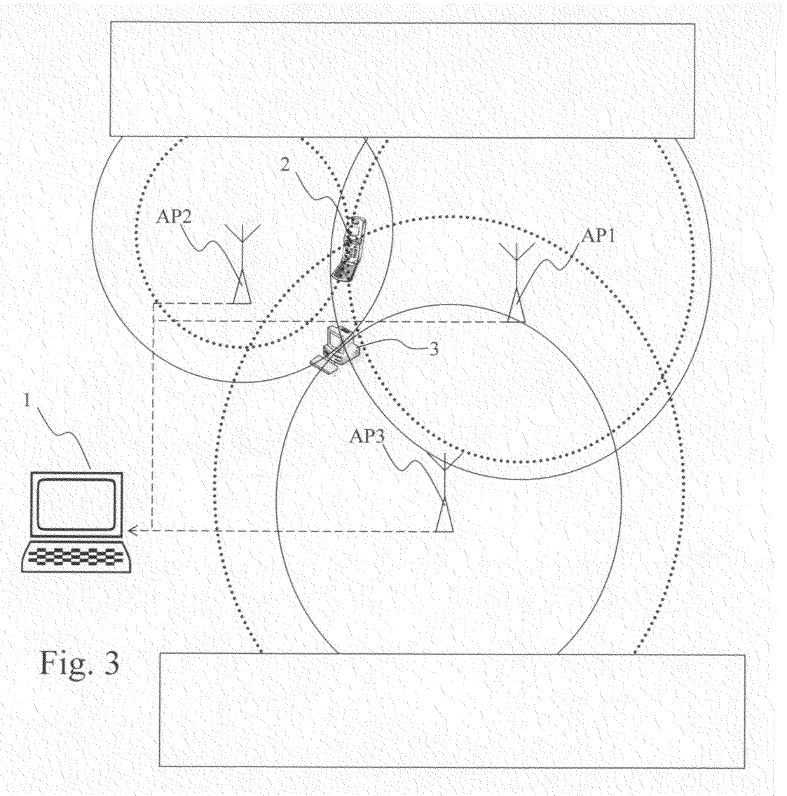

According to one embodiment of the present invention, in Step S25, after the most neighboring fixed wireless communication modules are found out via comparing the signal intensity data obtained by a mobile communication device with the signal intensity data of fixed wireless communication modules, the ratio of signal intensity to distance is used to calculate the intensity attenuation ratio, as shown in FIG. 3. The fixed wireless communication modules are immobile at the fixed reference points, and the fixed reference point data has been stored in the database of the LAN server 1; therefore, the correct position of the mobile communication device 2 can be worked out.

In Step S27, the data stored in the LAN server for positioning a mobile communication device includes the following types. A first type of data is the positions and time parameters of access points. A second type of data is the positions and signal intensity data of fixed wireless communication devices, which may be updated periodically. A third type of data is the signal intensity data and calculated position of a mobile communication device; the type of data will be reviewed to determine whether it is still valid when the position of a new mobile communication device is entered; if the answer is negative, the preceding data will be cleared, and only the newest data is retained.

According those described above, it is known that the present invention searches for the most neighboring points and utilizes a signal attenuation method to work out the physical position of a mobile communication device. Thereby, complicated calculation is simplified; uncertain factors, such as signal reflection and barrier interference, are reduced, and positioning accuracy is promoted. The data of the recently positioned object is fed back to the system and functions as a sample. The more the samples, the more accurate the calculated position of a mobile communication device.

In one embodiment of the present invention, the system and method of the present invention can be used to position any person carrying a mobile communication device in a tall building, wherein a main server receives the information from all LAN servers on the floors via the building's network and functions as the personnel positioning/administration system and thus provides diversified services.

In summary, under the environment of widely established wireless local area networks, the present invention proposes a wireless network positioning system and a method for the same, wherein a mobile communication device receives several wireless signals of different intensities, and an algorithm is used to compare the intensities with the intensity of neighboring fixed wireless communication modules to calculate the position of the mobile communication device according to the positions of the fixed wireless communication modules; then, the positional information is fed back to the mobile communication device.

Those described above are the embodiments to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. A wireless network positioning system comprising:
at least one local area network server administrating a wireless local area network;
a plurality of access points arranged in said wireless local area network and communicating with said local area network server, wherein each access point has a footprint and a piece of positional data, and said footprint overlaps footprints of neighboring said access points, and all said footprints jointly form a wireless communication coverage; and
at least one fixed wireless communication module arranged at a fixed position of said wireless communication coverage and receiving wireless signals of said access points to obtain a plurality of pieces of signal intensity data with said fixed position stored in said local area network server and functioning as a piece of fixed reference point data,
wherein said plurality of pieces of signal intensity data are respectively transmitted to said access points, which further transmit said signal intensity data to said local area network server, and said local area network server processes said signal intensity data and said fixed reference point data and utilizes an algorithm to work out a piece of positional data of a mobile communication device inside said wireless communication coverage.

2. A wireless network positioning system according to claim 1, wherein said local area network server is linked to an internet.

3. A wireless network positioning system according to claim 1, wherein said wireless local area network is a wireless communication network meeting the IEEE802.11 standard.

4. A wireless network positioning system according to claim 1, wherein said access points are linked to said local area network server with a wireless method or a wired method.

5. A wireless network positioning system according to claim 1, wherein said fixed wireless communication module is arranged inside a computer.

6. A wireless network positioning system according to claim 5, wherein said computer is a desktop computer or a notebook computer.

7. A wireless network positioning system according to claim 1, wherein said fixed wireless communication module is arranged inside an intelligent household electric appliance, which is wirelessly linked to an internet.

8. A wireless network positioning system according to claim 1, wherein said mobile communication device is an intelligent mobile phone, a pocket computer, a palm computer, or a notebook computer.

9. A wireless network positioning system according to claim 1, wherein said algorithm is a Euclidean distance algorithm.

10. A wireless network positioning system according to claim 9, wherein said algorithm further comprises a multi-point positioning method which compares said signal intensity data of said mobile communication device with said fixed reference point data to obtain an intensity attenuation ratio.

11. A wireless network positioning system comprising: a mobile communication device, at least one local area network server and a plurality of access points, wherein said mobile communication device entering a wireless communication coverage, which is formed of footprints of wireless signals emitted by said plurality of access points and said mobile communication device scanning said wireless signals to outputting a plurality of pieces of signal intensity data, then said mobile communication device transmitting a positional information query and said signal intensity data to a local area network server utilizing an algorithm to work out a piece of positional information of said mobile communication device, and
said local area network transmitting said positional information to said mobile communication device.

12. A wireless network positioning system according to claim 11, wherein said local area network server administrates a wireless local area network and is linked to an internet.

13. A wireless network positioning system according to claim 11, wherein said mobile communication device is an intelligent mobile phone, a pocket computer, a palm computer, or a notebook computer.

14. A wireless network positioning system according to claim 11, wherein at least one fixed wireless communication module is arranged in at least one fixed position of said wireless communication coverage and receives wireless signals of said access points to obtain at least one piece of signal intensity data of said at least one fixed position.

15. A wireless network positioning system according to claim 14, wherein said fixed wireless communication module is arranged inside an intelligent household electric appliance wirelessly linked to an internet or inside a computer.

16. A wireless network positioning system according to claim 11, wherein said algorithm is a Euclidean distance algorithm.

17. A wireless network positioning system according to claim 16, wherein said algorithm further comprises a multi-point positioning method which compares said signal intensity data of said mobile communication device with fixed reference point data to obtain an intensity attenuation ratio.

18. A wireless network positioning system according to claim 11 further comprising storing said positional information in said local area network server.
